(19) United States
(12) Patent Application Publication
(10) Pub. No.: US 2026/0254148 A1
(43) Pub. Date: Aug. 27, 2026

(54) ELECTRICAL CONNECTOR

(71) Applicant: Molex, LLC, Lisle, IL (US)

(72) Inventors: Feng Chen, Shanghai City (CN); Dan Qu, Shanghai City (CN)

(21) Appl. No.: 19/542,700

(22) Filed: Feb. 18, 2026

(30) Foreign Application Priority Data
Feb. 21, 2025 (CN) 202510200016.5

(51) Int. Cl. H01R 13/506; H01R 12/70; H01R 12/71

(52) U.S. Cl. CPC H01R 13/506; H01R 12/7052; H01R 12/707; H01R 12/7082; H01R 12/714

(57) ABSTRACT

An electrical connector is provide and includes a housing with an interior that includes first terminal receiving grooves which are communicated with a outer connecting side and an inner connecting side; a rear cover that cooperates with the housing to form a penetrating window. An inner row of conductive terminals can be positioned in the first terminal receiving grooves so that soldering leg portions of the conductive terminals are exposed in the penetrating window. An outer row of conductive terminal can be positioned in the first terminal receiving grooves with soldering leg portions that are exposed to a side of the rear cover away from the housing. The electrical connector can provide two regions to expose the soldering leg portions of two types of signal terminals, can be compatible with a conventional AOI lens in industry to inspect vertically from up to down, and helps promotes inspecting.

### TECHNICAL FIELD

The present disclosure relates to field of electrical connectors, and specifically relates to an electrical connector.

### BACKGROUND

An electrical connector is a device which is used to bridge different electronic devices and ensures that a signal is correctly transferred, at present has been widely applied in fields, such as computer interface, communication, home appliance, automobile and the like, is an essential structure that a circuit in an electronic device realizes a preset function.

In the electrical connector in the prior art, soldering legs of a part of conductive terminals are only exposed on a lower surface of a housing, when viewed from up to down, the soldering legs will be blocked by the housing. When the electrical connector is soldered on a PCB by SMT, SMT manufacturer will inspect quality situation of solders at the soldering legs of the conductive terminals, based on a design at present, the SMT manufacturer needs to specially manufacture a relevant apparatus so that an Automated Optical Inspection (AOI) apparatus will be inclined by a certain angle to perform inspection, this cannot be compatible with an AOI apparatus which often vertically inspects from up to down.

### SUMMARY

Based on this, the present disclosure provides an electrical connector, the electrical connector is capable of providing a region which allows soldering leg portions of inner row signal terminals to be exposed in a vertical direction and a region which allows soldering leg portions of outer row signal terminals to be exposed in the vertical direction, is compatible with a conventional AOI lens in industry to inspect vertically from up to down, and promotes convenience of inspecting.

According to some embodiments, an aspect of the present disclosure provides an electrical connector, comprising: a housing, two sides of the housing respectively form an outer connecting side and an inner connecting side, an interior of the housing is provided with first terminal receiving grooves which are communicated with the outer connecting side and the inner connecting side; a rear cover which is attached to the inner connecting side of the housing, the rear cover and the housing cooperate with each other to form a penetrating window, inner row conductive terminals which are at least partially received in the first terminal receiving grooves, soldering leg portions of the inner row conductive terminals extend and are exposed in the penetrating window; and outer row conductive terminal which are at least partially received in the first terminal receiving grooves, soldering leg portions of the outer row conductive terminals extend and are exposed to a side of the rear cover away from the housing, along an observing direction provided by the penetrating window, the soldering leg portions of the inner row conductive terminals are staggered with the outer row conductive terminals.

Preferably, two ends of the inner connecting side of the housing each are provided with a protruding portion which protrudes toward the rear cover, the inner connecting side of the housing, inner sides of the protruding portions which face each other, and the rear cover cooperate with each other to form the penetrating window.

Preferably, the inner row conductive terminals comprises inner row signal terminals, the soldering leg portion of the inner row signal terminal is a first soldering leg portion; the inner row signal terminal further comprises: a first bent portion which is bent from an upper end of the first soldering leg portion and then extends along a first direction or a direction opposite to the first direction; a first body portion which is connected to a side of the first bent portion away from the first soldering leg portion; and a first terminal portion which is connected to a side of the first body portion away from the first soldering leg portion.

Preferably, a span of the first bent portion in the first direction is less than a half of a pitch between the two adjacent inner row signal terminals.

Preferably, the outer row conductive terminal comprises outer row signal terminals; the soldering leg portion of the outer row signal terminal is a second soldering leg portion; the outer row signal terminal further comprises: a second extending portion which extends along a third direction, and a lower portion of the second extending portion is connected to the second soldering leg portion; a second body portion which extends along a second direction, and a first side of the second body portion is connected to an upper portion of the second extending portion; and a second terminal portion which is connected to a second side of the second body portion.

Preferably, the housing is a flat connector outer housing, and is provided with a flat mating space which is communicated with the first terminal receiving grooves and the outer connecting side, the inner row conductive terminals are at least partially exposed on a lower surface of an interior of the flat mating space, the outer row conductive terminals are at least partially exposed on an upper surface of the interior of the flat mating space.

Preferably, the inner row conductive terminals comprise inner row power terminals which are respectively provided in two sides of the flat connector outer housing; the outer row conductive terminals comprise outer row power terminals which are respectively provided in the two sides of the flat connector outer housing; a first power supplying end of the inner row power terminal passes through the corresponding first terminal receiving groove and is at least partially exposed on the lower surface of the interior of the flat mating space; a second power supplying end of the outer row power terminal passes through the corresponding first terminal receiving groove and is at least partially exposed on the upper surface of the interior of the flat mating space.

Preferably, the outer row power terminal has a first bent surface, a second bent surface and a third bent surface which are continuous, at least one side of the second bent surface is provided with a stopping surface which extends outwardly, the stopping surface is positioned in a position-limiting groove of the housing.

Preferably, the electrical connector further comprises two limiting members; two sides of the housing each are provided with a mounting groove which extends in a third direction, two sides of an upper surface of the rear cover each are provided with a first recessed portion, a main body portion of the limiting member is positioned in the mounting groove, a first end of a first side of the limiting member is provided with a first position-limiting portion, the first position-limiting portion is assembled in the first recessed portion by press fit.

Preferably, two sides of an upper surface of the housing each are provided with a second recessed portion, a second end of the first side of the limiting member is provided with a second position-limiting portion, the second position-limiting portion is assembled in the second recessed portion by press fit.

Preferably, two sides of an upper portion of the main body portion of the limiting member respectively have a first bent lug and a second bent lug which are bent inwardly, the first bent lug and the second bent lug respectively form the first position-limiting portion and the second position-limiting portion, the first bent lug and the second bent lug each are perpendicular to the main body portion.

Preferably, a lower portion of the main body portion of the limiting member is provided with a third bent lug which is bent outwardly.

Preferably, one part of an upper surface of the first recessed portion is higher than the other part of the upper surface of the first recessed portion.

Preferably, the protruding portion of the housing is provided with a snapping groove, two sides of the rear cover each are provided with a snapping portion, the snapping portion and the snapping groove snap with each other.

Preferably, the snapping portion is provided thereon with a rib which engages with the snapping groove by interference fit.

The present disclosure is capable of providing a region which allows the soldering leg portions of the inner row signal terminals to be exposed in the vertical direction and a region which allows the soldering leg portions of the outer row signal terminals to be exposed in the vertical direction, is compatible with a conventional AOI lens in industry to inspect vertically from up to down, and promotes convenience of inspecting.

The other advantages, objects and features of the present disclosure will be described in the subsequent description to some extent, and will be apparent to those skilled in the art to some extent based on the investigation and research of the following content, or can be taught from the practice of the present disclosure. The objects and other advantages of the present disclosure can be realized and obtained through the following description.

### BRIEF DESCRIPTION OF THE DRAWINGS

Other features, objects, and advantages of the present disclosure will become more apparent by reading the detailed description of non-limiting embodiments with reference to the accompanying drawings.

FIG. 1 is a perspective view of an electrical connector of the present disclosure mounted on a PCB viewed from a first angle.

FIG. 2 is an exploded view of the electrical connector of the present disclosure viewed from an inner connecting side.

FIG. 3 is a perspective view of the electrical connector of the present disclosure mounted on the PCB viewed from a second angle.

FIG. 4 is an exploded view of the electrical connector of the present disclosure viewed from an outer connecting side.

FIG. 5 is a top view of the electrical connector of the present disclosure.

FIG. 6 is a cross-sectional view along a line A-A of FIG. 5.

FIG. 7 is a cross-sectional view along a line B-B of FIG. 5.

FIG. 8 is an enlarged view of a region C of FIG. 7.

FIG. 9 is a cross-sectional view along a line D-D of FIG. 5.

FIG. 10 is a schematic view of the electrical connector of the present disclosure viewed from a rear cover side.

FIG. 11 is a cross-sectional view along a line H-H of FIG. 10.

FIG. 12 is an enlarged view of a region J of FIG. 11.

FIG. 13 is a perspective view of a rear cover of the electrical connector of the present disclosure.

FIG. 14 is an enlarged view of a region M of FIG. 13.

FIG. 15 is a perspective view of an inner row signal terminal of the electrical connector of the present disclosure.

FIG. 16 is a perspective view of an outer row signal terminal of the electrical connector of the present disclosure.

FIG. 17 is a perspective view of the electrical connector of the present disclosure with the rear cover removed.

FIG. 18 is a schematic view of the electrical connector of the present disclosure viewed from the inner connecting side with the rear cover removed.

FIG. 19 is an enlarged view of a region K of FIG. 18.

FIG. 20 is a schematic view of the electrical connector of the present disclosure viewed from the outer connecting side with the rear cover removed.

FIG. 21 is a cross-sectional view along a line E-E of FIG. 20.

FIG. 22 is a cross-sectional view long a line F-F of FIG. 20.

FIG. 23 is a perspective view of an inner row power terminal of the electrical connector of the present disclosure.

FIG. 24 is a perspective view of an outer row power terminal of the electrical connector of the present disclosure.

### DETAILED DESCRIPTION

Hereinafter the implementation of the present disclosure is described by specific instances, those skilled in the art can easily understand the other advantages and effects of the present disclosure from the disclosed content of the present disclosure. The present disclosure can also be implemented or applied through different specific implementation manners, and various details in the present disclosure can be modified or changed according to different perspectives and application systems without departing from the spirit of the present disclosure. It should be noted that embodiments and features in the embodiments of the present disclosure can be combined with each other without conflict.

Hereinafter the embodiments of the present disclosure will be described in detail with reference to the accompanying drawings, so that those skilled in the art to which the present disclosure belongs can easily implement them. The present disclosure can be embodied in various forms and is not limited to the embodiments described herein.

In the representation of the present disclosure, reference terms “one embodiment”, “some embodiments”, “examples”, “specific examples”, or “some examples” and the like mean that the specific features, structures, materials, or characteristics represented by the embodiment or example are included in at least one embodiment or example of the present disclosure. Moreover, the specific features, structures, materials, or characteristics represented can be combined in any one or more embodiments or examples in an appropriate manner. In addition, technicians in this field can engage and combine the different embodiments or examples represented in the present disclosure as well as the features of different embodiments or examples, without conflicting with each other.

In addition, the terms “first” and “second” are only used to indicate the purpose and cannot be understood as indicating or implying relative importance or implying the number of technical features indicated. Therefore, the features that are defined with “first” and “second” can explicitly or implicitly include at least one of these features. In the representation of this application, the meaning of “multiple” refers to two or more, unless otherwise specifically limited.

In order to clarify the present disclosure, components unrelated to the description are omitted, and the same or similar constituent elements throughout the specification are given the same reference numerals.

Throughout the specification, when it is said that a component is “connected” to another component, this includes not only the situation of “direct connection”, but also the situation of “indirect connection” by placing other components in between. In addition, when a certain component “includes” a certain constituent element, as long as there is no particularly opposite record, it does not exclude other constituent elements, but means that other constituent elements can also be included.

When a component is “above” another component, the component can be directly above another component, but it can also be accompanied by other component between the component and another component. When a component is said to be “directly” on top of another component, there is no other component between the component and another component.

Although the terms first, second, etc. are used herein to refer to various elements in some instances, these elements should not be limited by these terms. These terms are only used to distinguish one element from another element. For example, a first interface and a second interface are represented. Furthermore, as used herein, the singular forms “a/an”, “one”, and “the” are intended to include the plural form as well, unless the context indicates otherwise. It should be further understood that the terms “include” and “comprise” indicate the existence of features, steps, operations, elements, components, items, categories, and/or groups, but do not exclude the existence, appearance, or addition of one or more other features, steps, operations, elements, components, items, categories, and/or groups. The terms “or” and/or “used here are interpreted as inclusive or imply any one or any combination. Therefore, ”A, B, or C“ or ”A, B, and/or C“ means ”any of the following: A; B; C. A and B; A and C; B and C; A, B, and C. Exceptions to this definition only occur when a combination of elements, functions, steps, or operations are inherently mutually exclusive in certain ways.

The professional terms used here are only intended to refer to specific embodiments and are not intended to limit the scope of the present disclosure. The singular form used here also includes the plural form as long as the statement does not clearly indicate the opposite meaning. The meaning of “include” used in the specification is to specify specific characteristics, regions, integers, steps, tasks, elements, and/or components, and does not exclude the existence or addition of other characteristics, regions, integers, steps, tasks, elements, and/or components.

Although not defined differently, including the technical and scientific terms used herein, all terms have the same meaning as those generally understood by those skilled in the art to which the present disclosure belongs. The additional interpretation of terms defined in commonly used dictionaries is to have meanings that are consistent with relevant technical literature and current prompts. As long as they are not defined, they should not be overly interpreted as ideal or very formulaic meanings.

In the electrical connector in the prior art, soldering legs of a part of conductive terminals are only exposed on a lower surface of a housing, when viewed from up to down, the soldering legs will be blocked by the housing. When the electrical connector is soldered on a PCB by SMT, SMT manufacturer will inspect quality situation of solders at the soldering legs of the conductive terminals, based on a design at present, the SMT manufacturer has to need to specially manufacture a relevant apparatus so that an AOI apparatus will be inclined by a certain angle to perform inspection, this cannot be compatible with an AOI apparatus which often vertically inspects from up to down, complexity of the AOI apparatus is increased.

Based on this, the present disclosure provides an electrical connector 10, the electrical connector 10 is capable of providing a region which allows soldering leg portions of inner row conductive terminals to be exposed in a vertical direction and a region which allows soldering leg portions of outer row conductive terminals to be exposed in the vertical direction, is compatible with a conventional AOI lens in industry to inspect vertically from up to down, and promotes convenience of inspecting. The detailed contents of the electrical connector 10 will be described in subsequent embodiments.

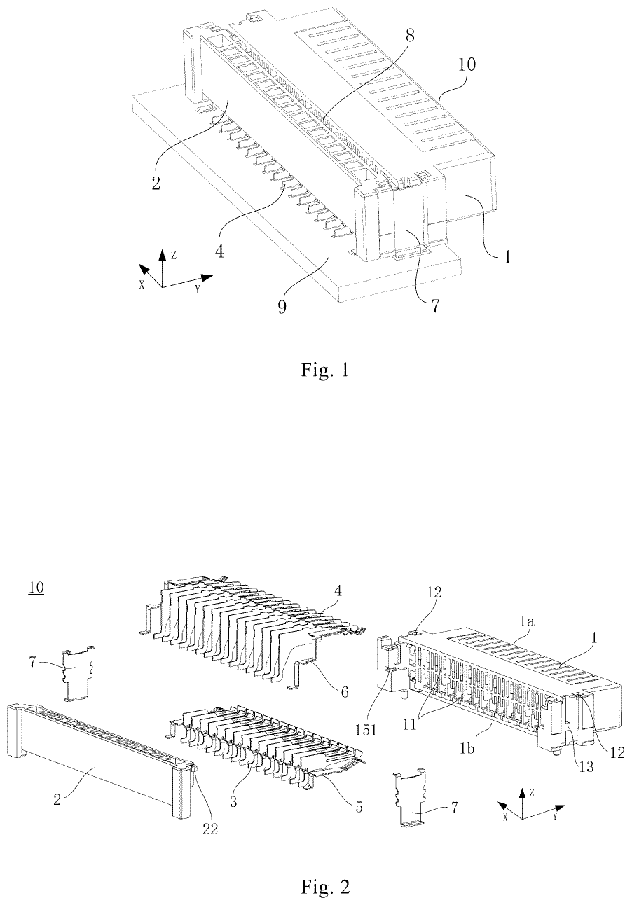

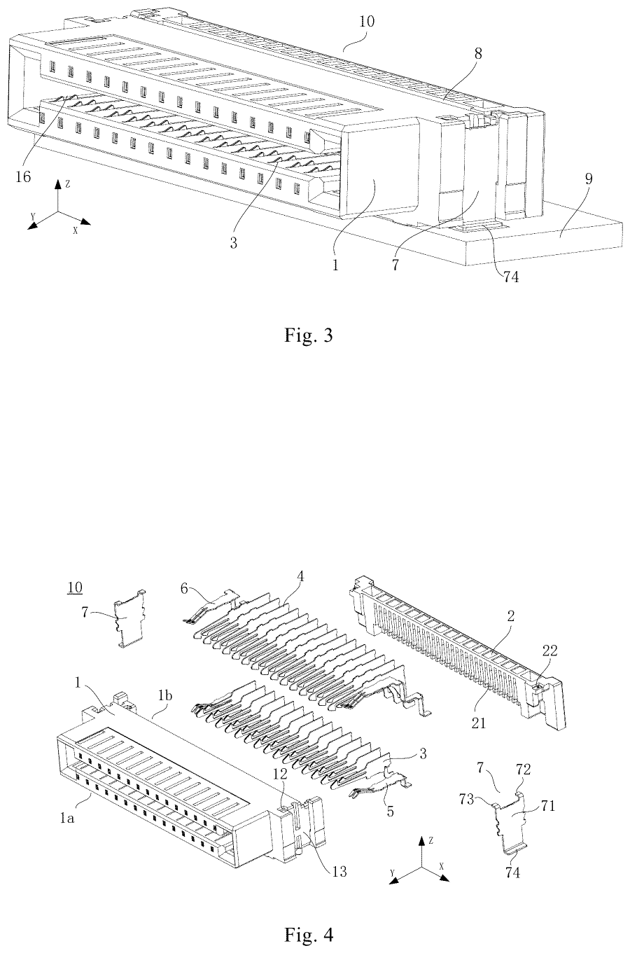

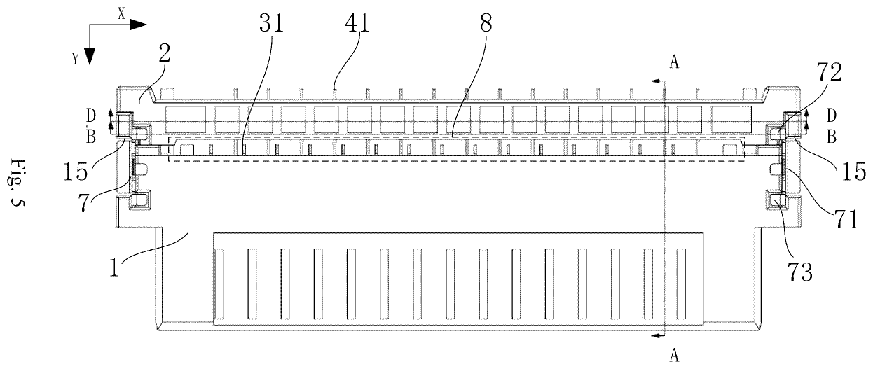

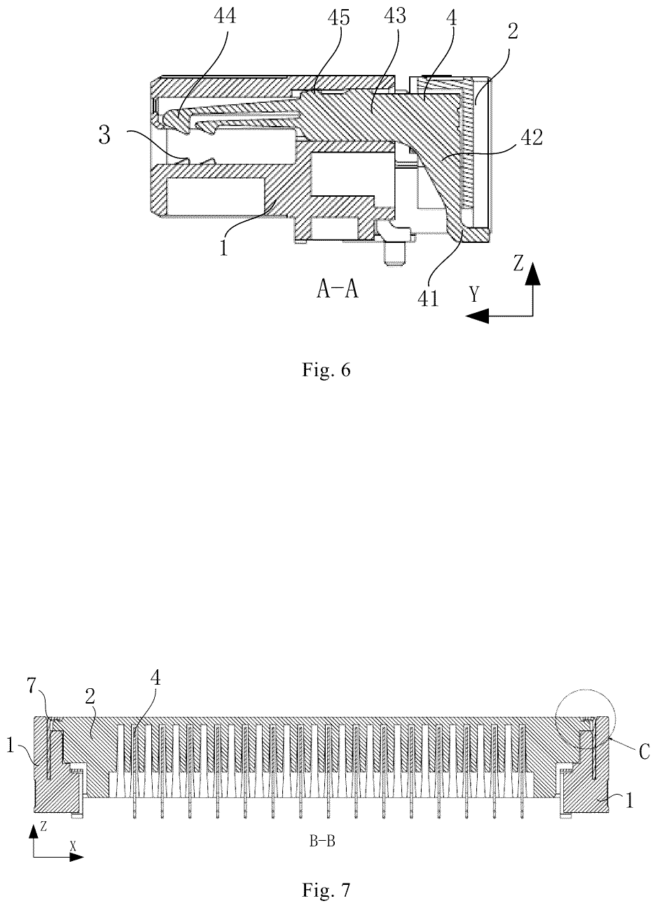

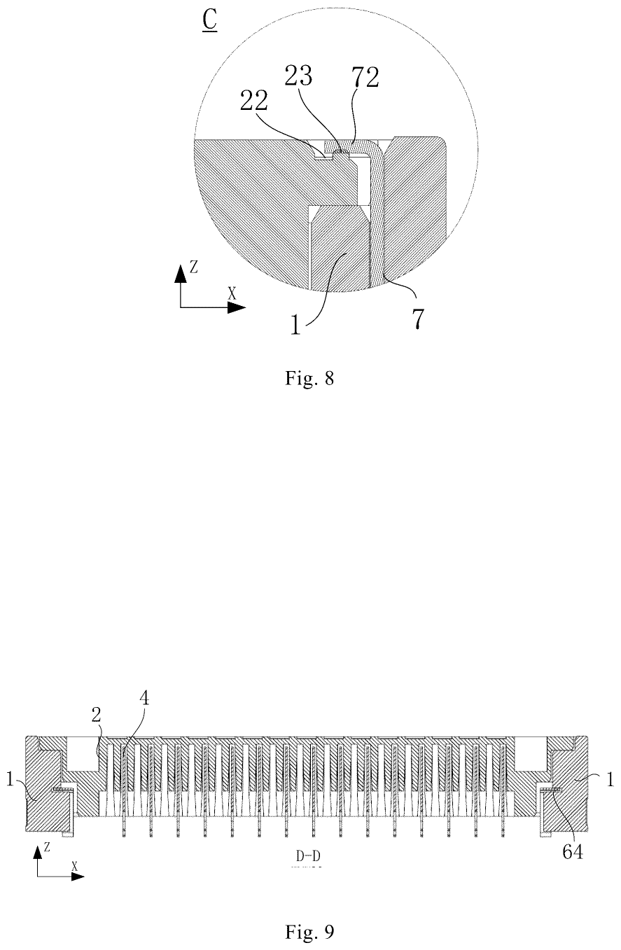

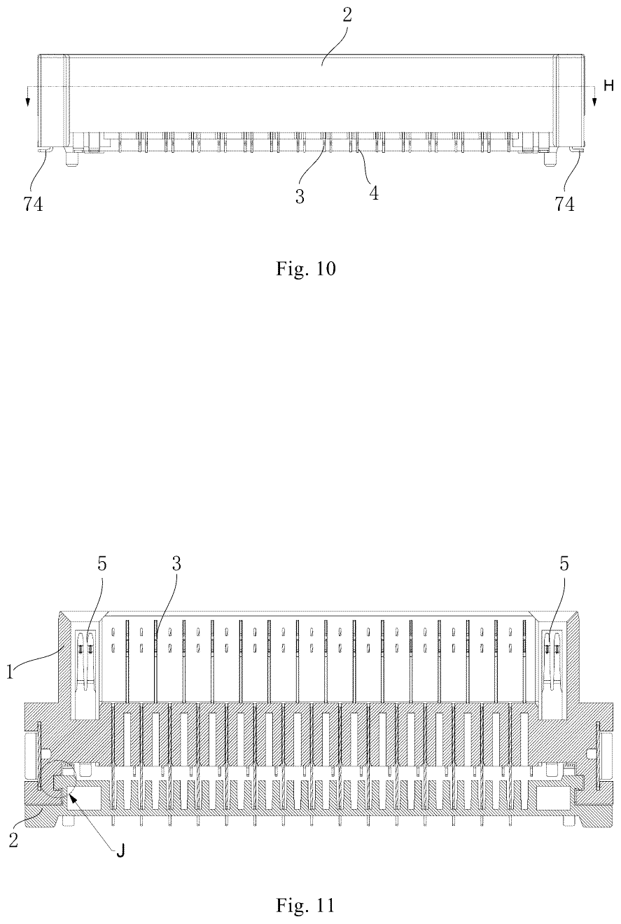

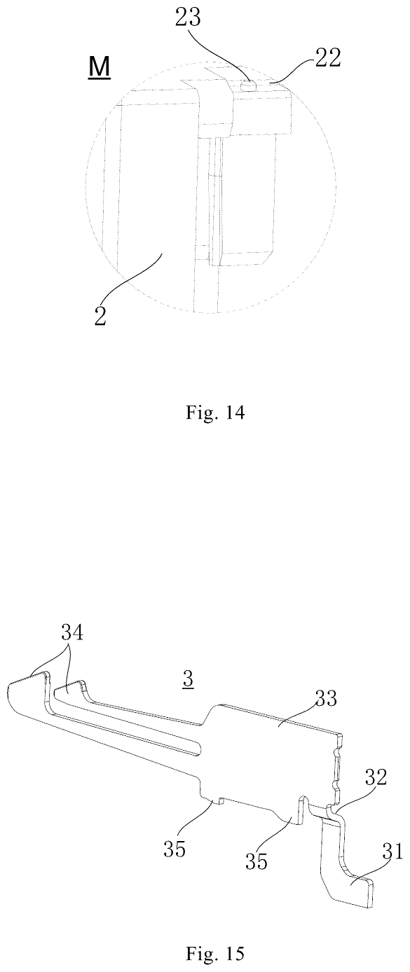

Referring to FIG. 1 to FIG. 14, specifically, an electrical connector 10 of the present disclosure may include a housing 1, a rear cover 2, inner row conductive terminals and outer row conductive terminals. In some embodiments, the inner row conductive terminals include inner row signal terminals 3, and the outer row conductive terminals include outer row signal terminals 4.

Two sides of the housing 1 respectively form an outer connecting side la and an inner connecting side 1b, an interior of the housing 1 is provided with first terminal receiving grooves 11 which are communicated with the outer connecting side la and the inner connecting side 1b. The rear cover 2 is attached to the inner connecting side 1b of the housing 1, the rear cover 2 and the housing 1 cooperate with each other to together form a penetrating window 8.

The inner row signal terminals 3 (specifically see FIG. 15) are at least partially received in the first terminal receiving grooves 11, first soldering leg portions 31 of the inner row signal terminal 3 extend and are exposed in the penetrating window 8, soldering situation of the first soldering leg portions 31 may be inspected through the penetrating window 8. Along an observing direction provided by the penetrating window 8, the first soldering leg portions 31 and the outer row signal terminals 4 are staggered with each other.

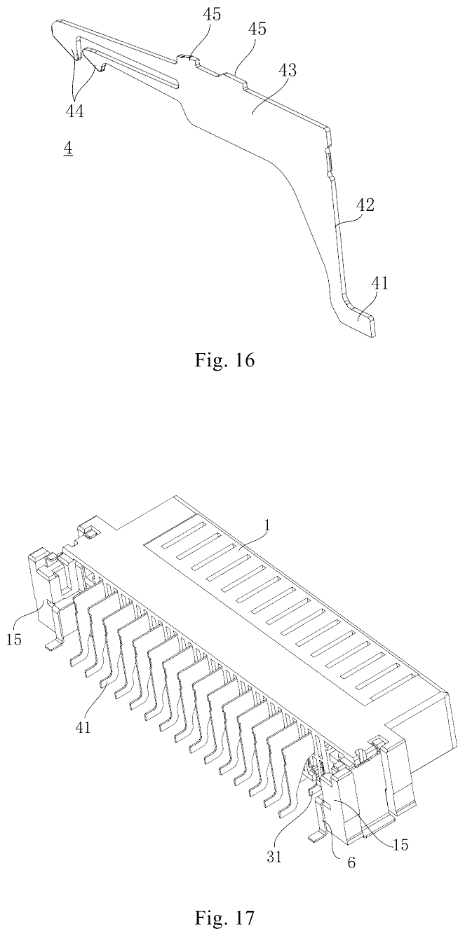

The outer row signal terminals 4 (specifically see FIG. 16) at least partially are received in the first terminal receiving grooves 11, second soldering leg portions 41 of the outer row signal terminals 4 extend and are exposed to a side of the rear cover 2 away from the housing 1. A region at a rear side of the rear cover 2 may be used to inspect soldering situation of the second soldering leg portions 41.

Therefore, by cooperation between the housing 1 and the rear cover 2, the first soldering leg portions 31 of the inner row signal terminals 3 and the second soldering leg portions 41 of the outer row signal terminals 4 may be exposed in a vertical direction at the same time, so a difficulty in inspecting the soldering situation of the first soldering leg portions 31 and the soldering situation of the second soldering leg portions 41 is simplified.

In the electrical connector 10, two ends of the inner connecting side 1b of the housing 1 each are provided with a protruding portion 15 which protrudes toward the rear cover 2, the inner connecting side 1b of the housing 1, inner sides of the protruding portions 15 which face each other, and the rear cover 2 cooperate with each other to form the penetrating window 8. Particularly, the first soldering leg portions 31 of the inner row signal terminals 3 which will be blocked by outer row signal terminals in the prior art may be exhibited in the penetrating window 8 which is an independent region. It is particularly adapted to an AOI apparatus that vertically inspects from up to down, under a precondition that the AOI apparatus may not employ an inclined camera, soldering quality situation of soldering leg portions is directly observed, convenience of inspecting steps is promoted, inspecting time is shortened, but the present disclosure is not limited thereto. In addition, the housing 1 and the rear cover 2 which are separable from each other also facilitate mounting of the terminals, manufacturing process is simple.

In a practical inspecting process, the structure of the present disclosure is capable of providing a region which allows the soldering leg portions of the inner row signal terminals to be exposed in the vertical direction and a region which allows the soldering leg portions of the outer row signal terminals to be exposed in the vertical direction, is compatible with a conventional AOI lens in industry to synchronously inspect soldering quality of the soldering leg portions of the inner row signal terminals and soldering quality of the soldering leg portions of the outer row signal terminals vertically from up to down, and greatly promotes convenience of inspecting.

In the electrical connector 10, the rear cover 2 may be provided with second terminal receiving grooves 21 which only receive the outer row signal terminals 4, to enhance protection for second body portions 43 of the outer row signal terminals 4 and prevent the second body portions 43 of the outer row signal terminals 4 from being deformed, but the present disclosure is not limited thereto.

In the electrical connector 10, the first terminal receiving grooves 11 are arranged along a first direction X in the housing 1 and extend parallel to each other along a second direction Y, the first direction X is perpendicular to the second direction Y, the observing direction of the penetrating window 8 is a third direction Z, the third direction Z is perpendicular to a plane where the first direction X and the second direction Y are presented, but the present disclosure is not limited thereto.

In the electrical connector 10, in a range of the housing 1, the inner row signal terminals 3 and the outer row signal terminals 4 are stagger with each other in the third direction Z, but the present disclosure is not limited thereto.

In the electrical connector 10, the housing 1 is a flat connector outer housing, is provided with a flat mating space 16 which is communicated with the first terminal receiving grooves 11 and the outer connecting side la, the inner row signal terminals 3 are at least partially exposed on a lower surface of an interior of the flat mating space 16, the outer row signal terminals 4 are at least partially exposed on an upper surface of the interior of the flat mating space 16, but the present disclosure is not limited thereto.

In the electrical connector 10, the rear cover 2 is provided with second terminal receiving grooves 21 which only receive the outer row signal terminals 4, to enhance protection for second extending portions 42 and the second body portions 43 of the outer row signal terminals 4, and avoid the outer row signal terminals 4 being deformed.

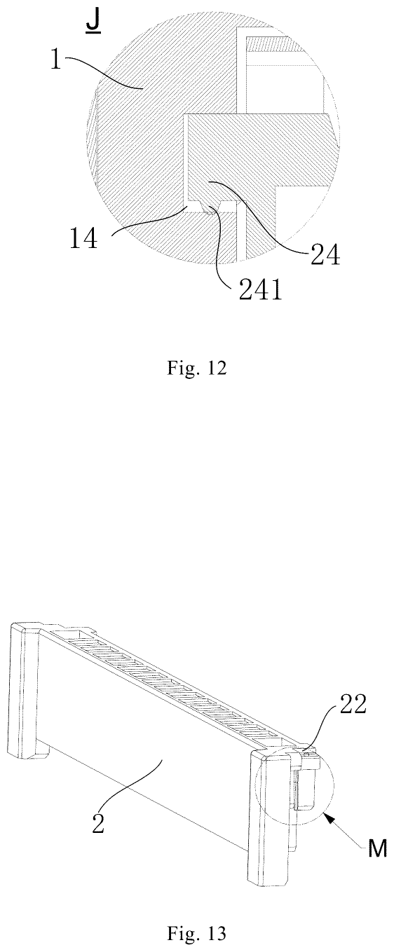

In the electrical connector 10, as shown in FIG. 11 and FIG. 12, the protruding portion 15 of the housing 1 is provided with a snapping groove 14, two sides of the rear cover 2 each are provided with a snapping portion 24, the snapping portion 24 and the snapping groove 14 snap with each other. Preferably, the snapping portion 24 is provided with a rib 241 which engages with the snapping groove 14 in interference fit so that the housing 1 and the rear cover 2 snap with each other.

In the electrical connector 10, the electrical connector 10 further includes two limiting members 7. Two sides of the housing 1 each are provided with a mounting groove 13 which extends in the third direction Z, two sides of an upper surface of the rear cover 2 each are provided with a first recessed portion 22, a main body portion 71 of the limiting member 7 slides into the mounting groove 13, a first end of a first side of the limiting member 7 is provided with a first position-limiting portion, the first position-limiting portion is assembled into the first recessed portion 22 by press fit to limit displacement of the rear cover 2 in the third direction Z. Two sides of an upper surface of the housing 1 each are provided with a second recessed portion 12, a second end of the first side of the limiting member 7 is provided with a second position-limiting portion, the second position-limiting portion is assembled into the second recessed portion 12 by press fit to limit displacement of the housing 1 in the third direction Z, so that position-limiting effect is enhanced.

One part of an upper surface of the first recessed portion 22 is higher than the other part of the upper surface of the first recessed portion 22. When the limiting member 7 is assembled, the limiting member 7 applies a pressure from up to down to flatten a projecting portion 23. For example, when the projecting portion 23 is not subjected to the pressure, a height of the projecting portion 23 is 0.1 mm, after the projecting portion 23 is subjected to the pressure, the projecting portion 23 is flattened so that the height of the projecting portion 23 is 0.03 mm. The height before the projecting portion 23 is subjected to the pressure and the height after the projecting portion 23 is subjected to the pressure height may be adjusted according to practical situation. In comparison with a case that the first position-limiting portion is directly pressed into the first recessed portion 22 without the projecting portion 23, a contacting area between the first position-limiting portion and the projecting portion 23 is smaller, a reacting force subjected by the first position-limiting portion is smaller, which avoids the first position-limiting portion generating deformation due to a too large reacting force, and thus assures assembling effect between the limiting member 7 and the rear cover 2.

Two sides of an upper portion of the main body portion 71 of the limiting member 7 respectively have a first bent lug 72 and a second bent lug 73 which are bent inwardly, the first bent lug 72 and the second bent lug 73 respectively form the first position-limiting portion and the second position-limiting portion, the first bent lug 72 and the second bent lug 73 each are perpendicular to the main body portion 71. A lower portion of the main body portion 71 of the limiting member 7 is provided with a third bent lug 74 which is bent outwardly, a bottom surface of the third bent lug 74 forms a positioning-soldering surface which is soldered with the PCB, so that, in cooperation with the PCB, a retaining force between the electrical connector 10 and the PCB is increased.

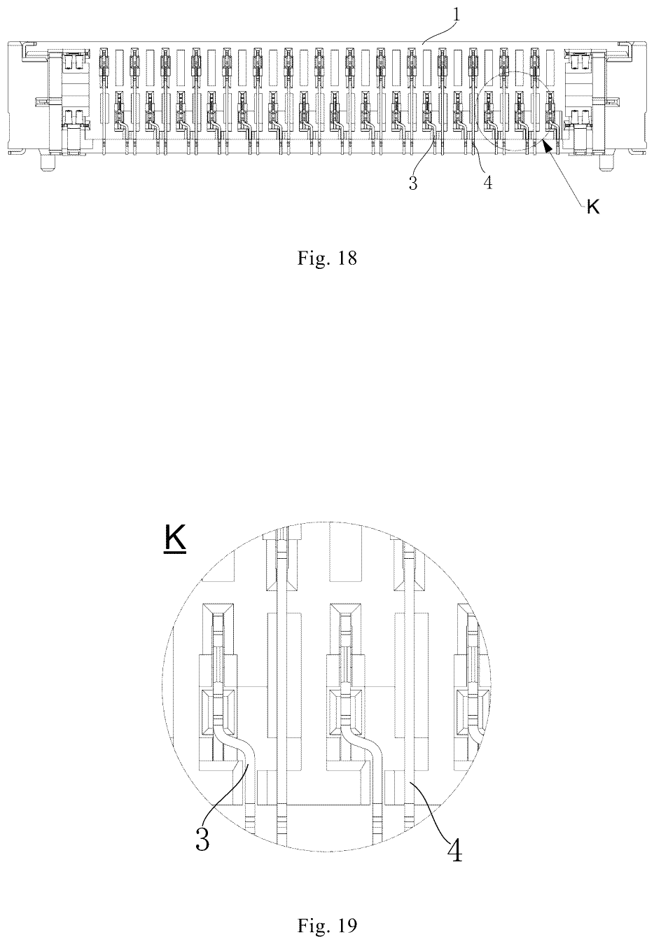

Referring to FIG. 15, FIG. 17 and FIG. 18, the inner row signal terminal 3 of the electrical connector 10 of the present disclosure further includes a first bent portion 32, a first body portion 33 and a first terminal portion 34. The first bent portion 32 is bent from an upper end of the first soldering leg portion 31 and then extends along the first direction X or a direction opposite to the first direction X. The first body portion 33 is a plate-shaped structure which is connected to a side of the first bent portion 32 away from the first soldering leg portion 31 and extends along the second direction Y. The first terminal portion 34 is connected to a side of the first body portion 33 away from the first soldering leg portion 31. The first bent portion 32 may adjust the first soldering leg portion 31 of the inner row signal terminal 3 to be stagger with the second soldering leg portion 41 of the outer row signal terminal 4 in the vertical direction. In other embodiments, arranged positions of the inner row signal terminals 3 and the outer row signal terminals 4 may be adjusted to make the soldering leg portions 31 of the inner row signal terminals 3 and the soldering leg portions 41 of the outer row signal terminals 4 are staggered with each other, in this case, the first bent portion 32 may be omitted, the first soldering leg portion 31 is directly connected to the first body portion 33.

Referring to FIG. 16, FIG. 17 and FIG. 18, the outer row signal terminal 4 of the electrical connector 10 of the present disclosure further includes a second extending portion 42, a second body portion 43 and a second terminal portion 44. The second extending portion 42 extends along the third direction Z, and a lower portion of the second extending portion 42 is connected to the second soldering leg portion 41. The second body portion 43 extends along the second direction Y, and a first side of the second body portion 43 is connected to an upper portion of the second extending portion 42. The second terminal portion 44 is connected to a side of the second body portion 43 away from the second extending portion 42. The outer row signal terminal 4 has the second extending portion 42 and the second body portion 43 which are robust so that a balance weight is increased to make a center of gravity of the outer row signal terminal 4 shifted rearwardly and prevent the electrical connector 10 from being entirely inclined forwardly with SMT, but the present disclosure is not limited thereto.

Referring to FIG. 19, in the electrical connector 10, a width of the first bent portion 32 is determined based on practical terminal rigidity, so the present disclosure is not specifically limited herein. A span of the first bent portion 32 in the first direction X is determined based on practical situation, for example, may be less than a half of a pitch between the inner row signal terminals 3, so as to be compatible with an electrical connector which has a small pitch (for example, 1.0 mm), but the present disclosure is not limited thereto.

In some embodiments, in the range of the housing 1, the inner row signal terminals 3 and the outer row signal terminals 4 are aligned with each other in the third direction Z as one-to-one correspondence. Specifically, the first terminal portion 34 of the inner row signal terminal 3 and the second terminal portion 44 of the outer row signal terminal 4 are positioned in the same vertical plane. But, a rear portion of the inner row signal terminal 3 utilizes the lengthened first bent portion 32 to make the first soldering leg portion 31 of the inner row signal terminal 3 offset to between the two adjacent outer row signal terminals 4, so that the first soldering leg portion 31 is completely exposed in a range where the penetrating window 8 is presented, the other technical features can be those as described above and are not repeated described herein.

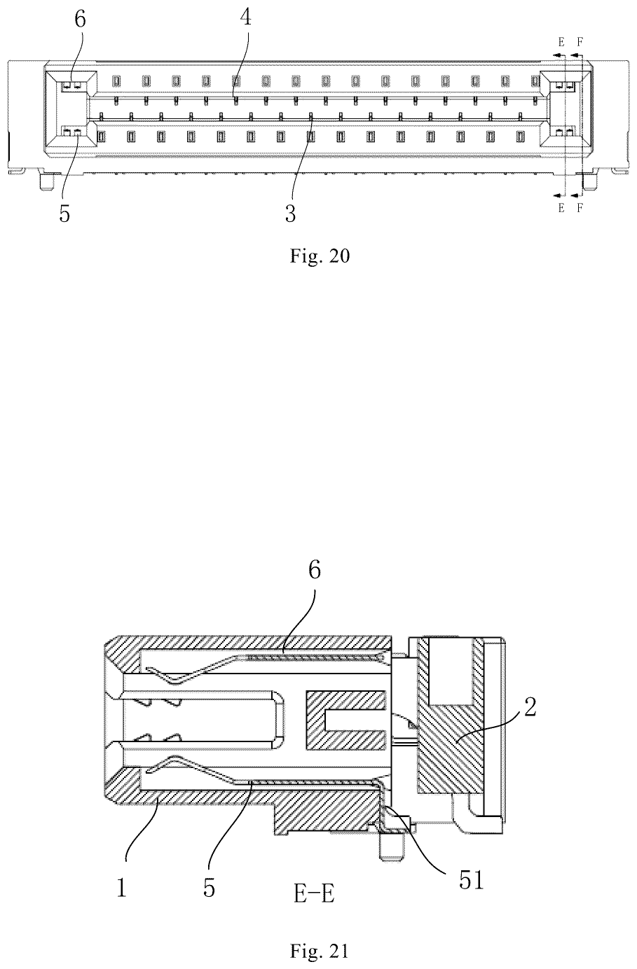

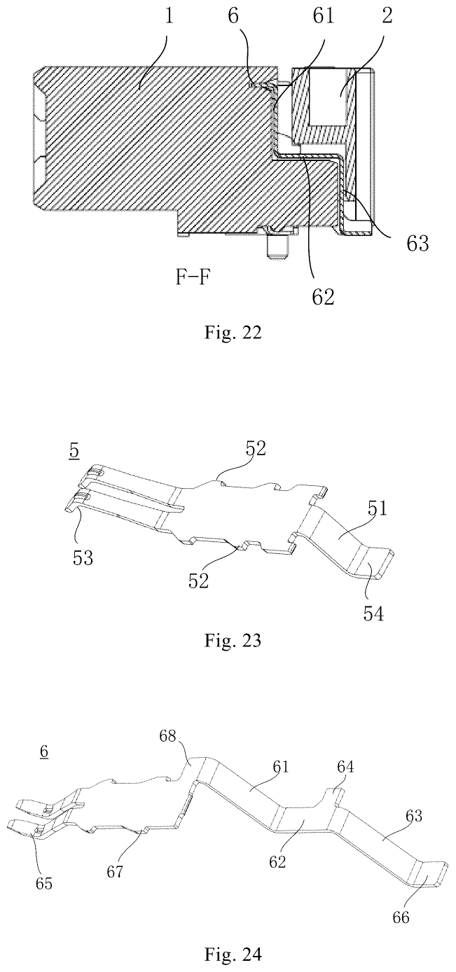

Referring to FIG. 20 to FIG. 24, in the electrical connector 10, optionally, the inner row conductive terminals further include inner row power terminals 5, the outer row conductive terminals further include outer row power terminals 6. The two sides of the flat connector outer housing each are provided therein with an inner row power terminal 5 and an outer row power terminal 6. A first power supplying end 53 of the inner row power terminal 5 passes through the corresponding first terminal receiving grooves 11 and is exposed on the lower surface of the interior of the flat mating space 16, a first soldering leg end 54 of the inner row power terminal 5 extends and is exposed in the penetrating window 8, the inner row power terminal 5 has a bent surface 51 which extends along an outer contour of the housing 1. A second power supplying end 65 of the outer row power terminal 6 passes through the corresponding first terminal receiving groove 11 and is exposed on the upper surface of the interior of the flat mating space 16, a second soldering leg end 66 of the outer row power terminal 6 extends and is exposed to a side of the rear cover 2 away from the housing 1, the outer row power terminal 6 have a first bent surface 61, a second bent surface 62 and a third bent surface 63 which are continuous and extend respectively along corresponding to outer contour surfaces of the housing 1. The outer contour surfaces of the housing 1 limit bent extent of the outer row power terminal 6, which prolongs service life of the outer row power terminal 6. The second power supplying end 65 and the first bent surface 61 are provided therebetween with a staggering portion 68, the staggering portion 68 extends along an arranged direction of the outer row conductive terminals, so that the staggering portion 68 is capable of making the inner row power terminal 5 and the outer row power terminal 6 staggered with each other. In the electrical connector 10, at least one side of the second bent surface 62 is provided with a stopping surface 64 which extends outwardly, the stopping surface 64 is positioned in a position-limiting groove 151 of the protruding portion 15 of the housing 1, which prevents the outer row power terminal 6 from being excessively deformed in the third direction Z to affect coplanarity of the second soldering leg end 66 with the soldering leg portions of the other conductive terminals, and enhances stability of the outer row power terminal 6.

In some embodiments, the housing 1 and the rear cover 2 are integrally formed by inject molding (not shown in the figures, that is, the housing 1 and the rear cover 2 do not need other position-limiting element or connecting element), other technical features can be those as described above and are not repeated described herein.

In some embodiments, at least one side edge of the first body portion 33 of the inner row signal terminal 3 is provided with a protrusion 35 which is capable of being retained in the housing 1. At least one side edge of the second body portion 43 of the outer row signal terminal 4 is provided with a protrusion 45 which is capable of being retained in the housing 1. Two side edges of the inner row power terminal 5 each are provided with a protrusion 52 which is capable of being retained in the housing 1. Two side edges of the outer row power terminal 6 each are provided with a protrusion 67 which is capable of being retained in the housing 1.

After the electrical connector 10 of the present disclosure is soldered on the PCB 9 (the first soldering leg portions 31 of the inner row signal terminals 3, the second soldering leg portions 41 of the outer row signal terminals 4, the first soldering leg ends 54 of the inner row power terminals 5, the second soldering leg ends 66 of the outer row power terminals 6 and the third bent lugs 74 of the limiting members 7 are soldered on corresponding pads on the PCB 9), a soldering leg of each conductive terminal is inspected. At this time, the soldering leg portions 31 of the inner row conductive terminals 3 extend and are exposed in the penetrating window 8, along the observing direction provided by the penetrating window 8, the soldering leg portions 41 of the inner row conductive terminals 4 are staggered with the outer row conductive terminals 3. The soldering leg portions 41 of the outer row conductive terminals 4 extend through the penetrating window 8 and are exposed to a side of the rear cover 2 away from the housing 1. With the structure of the electrical connector 10 of the present disclosure, after the electrical connector 10 is soldered on the PCB 9, a conventional AOI apparatus may perform inspection from up to down vertically, soldering quality situation of the soldering leg portion of each conductive terminal (that is, the inner row conductive terminal and the outer row conductive terminal) is correctly inspected at once, convenience of inspecting step is promoted, inspecting time is shortened.

The various technical features of the above embodiments can be combined in any way. In order to make the description concise, not all possible combinations of the various technical features of the above embodiments have been described. However, as long as there is no contradiction in the combination of these technical features, they should be considered within the scope of this specification.

The above embodiments only express several embodiments of the present disclosure, and their descriptions are more specific and detailed, but should not be understood as limiting the scope of the patent disclosure. It should be pointed out that, for ordinary technical personnel in this field, several variations and modification can be made without departing from the concept of the present disclosure, which are within the scope of protection of the present disclosure.

Therefore, the scope of protection of the present disclosure should be based on the appended claims.

What is claimed is:

1. An electrical connector, comprising:
a housing, two sides of the housing respectively forming an outer connecting side and an inner connecting side, an interior of the housing being provided with first terminal receiving grooves which are communicated with the outer connecting side and the inner connecting side;
a rear cover which is attached to the inner connecting side of the housing, the rear cover and the housing cooperating with each other to form a penetrating window;
inner row conductive terminals which are at least partially received in the first terminal receiving grooves, soldering leg portions of the inner row conductive terminals extending and being exposed in the penetrating window; and
outer row conductive terminal which are at least partially received in the first terminal receiving grooves, soldering leg portions of the outer row conductive terminals extending and being exposed to a side of the rear cover away from the housing, along an observing direction provided by the penetrating window, the soldering leg portions of the inner row conductive terminals being staggered with the outer row conductive terminals.

2. The electrical connector of claim 1, wherein
two ends of the inner connecting side of the housing each are provided with a protruding portion which protrudes toward the rear cover,
the inner connecting side of the housing, inner sides of the protruding portions which face each other, and the rear cover cooperate with each other to form the penetrating window.

3. The electrical connector of claim 1, wherein
the inner row conductive terminals comprises inner row signal terminals,
the soldering leg portion of the inner row signal terminal is a first soldering leg portion;
the inner row signal terminal further comprises:
a first bent portion which is bent from an upper end of the first soldering leg portion and then extends along a first direction or a direction opposite to the first direction;
a first body portion which is connected to a side of the first bent portion away from the first soldering leg portion; and
a first terminal portion which is connected to a side of the first body portion away from the first soldering leg portion.

4. The electrical connector of claim 3, wherein
a span of the first bent portion in the first direction is less than a half of a pitch between the two adjacent inner row signal terminals.

5. The electrical connector of claim 1, wherein
the outer row conductive terminal comprises outer row signal terminals;
the soldering leg portion of the outer row signal terminal is a second soldering leg portion;
the outer row signal terminal further comprises:
a second extending portion which extends along a third direction, and a lower portion of the second extending portion is connected to the second soldering leg portion;
a second body portion which extends along a second direction, and a first side of the second body portion is connected to an upper portion of the second extending portion; and
a second terminal portion which is connected to a second side of the second body portion.

6. The electrical connector of claim 1, wherein
the housing is a flat connector outer housing, and is provided with a flat mating space which is communicated with the first terminal receiving grooves and the outer connecting side,
the inner row conductive terminals are at least partially exposed on a lower surface of an interior of the flat mating space,
the outer row conductive terminals are at least partially exposed on an upper surface of the interior of the flat mating space.

7. The electrical connector of claim 6, wherein
the inner row conductive terminals comprise inner row power terminals which are respectively provided in two sides of the flat connector outer housing;
the outer row conductive terminals comprise outer row power terminals which are respectively provided in the two sides of the flat connector outer housing;
a first power supplying end of the inner row power terminal passes through the corresponding first terminal receiving groove and is at least partially exposed on the lower surface of the interior of the flat mating space;
a second power supplying end of the outer row power terminal passes through the corresponding first terminal receiving groove and is at least partially exposed on the upper surface of the interior of the flat mating space.

8. The electrical connector of claim 7, wherein
the outer row power terminal has a first bent surface, a second bent surface and a third bent surface which are continuous,
at least one side of the second bent surface is provided with a stopping surface which extends outwardly, the stopping surface is positioned in a position-limiting groove of the housing.

9. The electrical connector of claim 1, wherein
the electrical connector further comprises two limiting members;
two sides of the housing each are provided with a mounting groove which extends in a third direction,
two sides of an upper surface of the rear cover each are provided with a first recessed portion,
a main body portion of the limiting member is positioned in the mounting groove,
a first end of a first side of the limiting member is provided with a first position-limiting portion, the first position-limiting portion is assembled in the first recessed portion by press fit.

10. The electrical connector of claim 9, wherein
two sides of an upper surface of the housing each are provided with a second recessed portion,
a second end of the first side of the limiting member is provided with a second position-limiting portion, the second position-limiting portion is assembled in the second recessed portion by press fit.

11. The electrical connector of claim 9, wherein
two sides of an upper portion of the main body portion of the limiting member respectively have a first bent lug and a second bent lug which are bent inwardly,
the first bent lug and the second bent lug respectively form the first position-limiting portion and the second position-limiting portion,
the first bent lug and the second bent lug each are perpendicular to the main body portion.

12. The electrical connector of claim 11, wherein
a lower portion of the main body portion of the limiting member is provided with a third bent lug which is bent outwardly.

13. The electrical connector of claim 9, wherein
one part of an upper surface of the first recessed portion is higher than the other part of the upper surface of the first recessed portion.

14. The electrical connector of claim 2, wherein
the protruding portion of the housing is provided with a snapping groove,
two sides of the rear cover each are provided with a snapping portion, the snapping portion and the snapping groove snap with each other.

15. The electrical connector of claim 14, wherein
the snapping portion is provided thereon with a rib which engages with the snapping groove by interference fit.
